(19) United States
(12) Patent Application Publication
(10) Pub. No.: US 2022/0300799 A1
(43) Pub. Date: Sep. 22, 2022

(54) Neuro-Symbolic Approach for Entity Linking

(71) Applicant: International Business Machines Corporation, Armonk, NY (US)

(72) Inventors: Hang Jiang, Cambridge, MA (US); Sairam Gurajada, San Jose, CA (US); Lucian Popa, San Jose, CA (US); Prithviraj Sen, San Jose, CA (US); Alexander Gray, Yonkers, NY (US); Yunyao Li, San Jose, CA (US)

(73) Assignee: International Business Machines Corporation, Armonk, NY (US)

(21) Appl. No.: 17/202,406

(22) Filed: Mar. 16, 2021

(51) Int. Cl. G06N 3/08; G06N 3/04

(52) U.S. Cl. CPC G06N 3/08; G06N 3/0454

(57) ABSTRACT

A system, computer program product, and method are provided for entity linking in a logical neural network (LNN). A set of features are generated for one or more entity-mention pairs in an annotated dataset. The generated set of features is evaluated against an entity linking LNN rule template having one or more logically connected rules and corresponding connective weights organized in a tree structure. An artificial neural network is leveraged along with a corresponding machine learning algorithm to learn the connective weights. The connective weights associated with the logically connected rules are selectively updated and a learned model is generated with learned thresholds and the learned weights for the logically connected rules.

### BACKGROUND

The present embodiment(s) relate to a computer system, computer program product, and a computer-implemented method using artificial intelligence (AI) and machine learning for disambiguating mentions in text by linking them to entities in a knowledge graph. More specifically, the embodiments are directed to a logical neural network entity linking using interpretable rules, and learning corresponding connective weights and rules.

Entity linking is a task of disambiguating textual mentions by linking them to canonical entities provided by a knowledge graph. The general approach is directed at long text comprised of multiple sentences wherein exacting features measuring some degree or similarity between the mention and one or more candidate entities, and a disambiguation step through a non-learning heuristic to link the mention to an actual entity. Challenges in entity linking are directed at short text, such as a single sentence or question, and limited contextual surrounding mentions. Platforms that support short text include conversational systems, such as a chatbot. The embodiments shown and described herein are directed to an artificial intelligence (AI) platform to entity linking to mitigate the challenges associated with short text and their corresponding platform(s).

### SUMMARY

The embodiments disclosed herein include a computer system, computer program product, and computer-implemented method for disambiguating mentions in text by linking them to entities in a logical neural network using interpretable rules. Those embodiments are further described below in the Detailed Description. This Summary is neither intended to identify key features or essential features or concepts of the claimed subject matter nor to be used in any way that would limit the scope of the claimed subject matter.

In one aspect, a computer system is provided with a processor operatively coupled to memory, and an artificial intelligence (AI) platform operatively coupled to the processor. The AI platform is configured with a feature manager, an evaluator, and a machine learning (ML) manager configured with functionality to support entity linking in a logical neural network (LNN). The feature manager is configured to generate a set of features for one or more entity-mention pairs in an annotated dataset. The evaluator, which is operatively coupled to the feature manager, is configured to evaluate the generated set of features against an entity linking LNN rule template having one or more logically connected rules and corresponding connective weights organized in a hierarchical structure. The ML manager, which is operatively coupled to the evaluator, is configured to leverage an artificial neural network and a corresponding ML algorithm to learn the connective weights. The ML manager is further configured to selectively update the connective weights associated with the logically connected rules. A learned model is generated with learned thresholds and the learned connective weights for the logically connected rules.

In another aspect, a computer program product is provided with a computer readable storage medium having embodied program code. The program code is executable by the processing unit with functionality to generate a set of features for one or more entity-mention pairs in an annotated dataset. The generated set of features is evaluated against an entity linking LNN rule template having one or more logically connected rules and corresponding connective weights organized in a hierarchical structure. The program code supports functionality to leverage an artificial neural network and a corresponding machine learning algorithm to learn the connective weights. The connective weights associated with the logically connected rules are selectively updated, and a learned model is generated with learned thresholds and the learned connective weights for the logically connected rules.

In yet another aspect, a method is provided. A set of features are generated for one or more entity-mention pairs in an annotated dataset. The generated set of features is evaluated against an entity linking LNN rule template having one or more logically connected rules and corresponding connective weights organized in a hierarchical structure. An artificial neural network is leveraged along with a corresponding machine learning algorithm to learn the connective weights. The connective weights associated with the logically connected rules are selectively updated, and a learned model is generated with learned thresholds and the learned connective weights for the logically connected rules.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments, unless otherwise explicitly indicated.

FIG. 1 depicts a block diagram illustrating a computer system with tools to support a neuro-symbolic solution to entity linking, which in exemplary embodiment is applicant to short-text scenarios.

FIG. 2 depicts a block diagram a block diagram is provided illustrating the tools shown in FIG. 1 and their associated APIs.

FIGS. 3A-3C depict a flow chart to illustrate a process for learning thresholding operations and weights in an entity linking algorithm.

FIG. 4 depicts a flow chart to illustrate a process for using a LNN to learn new rules with appropriate weights for logical connectives.

FIG. 5 depicts a block diagram to illustrate an example LNN reformulation of an EL algorithm.

FIG. 6 is a block diagram depicting an example of a computer system/server of a cloud based support system, to implement the system and processes described above with respect to FIGS. 1-5.

FIG. 7 depicts a block diagram illustrating a cloud computer environment.

FIG. 8 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a data set to solve problems and provide relevant recommendations. For example, in the field of artificial intelligent computer systems, natural language (NL) systems (such as the IBM Watson® artificially intelligent computer system or other natural language interrogatory answering systems) process NL based on system acquired knowledge.

In the field of AI computer systems, natural language processing (NLP) systems process natural language based on acquired knowledge. NLP is a field of AI that functions as a translation platform between computer and human languages. More specifically, NLP enables computers to analyze and understand human language. Natural Language Understanding (NLU) is a category of NLP that is directed at parsing and translating input according to natural language principles. Examples of such NLP systems are the IBM Watson® artificial intelligent computer system and other natural language question answering systems.

Machine learning (ML), which is a subset of AI, utilizes algorithms to learn from data and create foresights based on the data. ML is the application of AI through creation of models, for example, artificial neural networks that can demonstrate learning behavior by performing tasks that are not explicitly programmed. There are different types of ML including learning problems, such as supervised, unsupervised, and reinforcement learning, hybrid learning problems, such as semi-supervised, self-supervised, and multi-instance learning, statistical inference, such as inductive, deductive, and transductive learning, and learning techniques, such as multi-task, active, online, transfer, and ensemble learning.

At the core of AI and associated reasoning lies the concept of similarity. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly. Existing solutions for efficiently identifying objects and understanding NL and processing content response to the identification and understanding as well as changes to the structures are extremely difficult at a practical level.

Artificial neural networks (ANNs) are models of the way the nervous system operates. Basic units are referred to as neurons, which are typically organized into layers. The ANN works by simulating a large number of interconnected processing units that resemble abstract versions of neurons. There are typically three parts in an ANN, including an input layer, with units representing input fields, one or more hidden layers, and an output layer, with a unit or units representing target field(s). The units are connected with varying connection strengths or weights. Input data is presented to the first layer, and values are propagated from each neuron to neurons in the next layer. At a basic level, each layer of the neural network includes one or more operators or functions operatively coupled to output and input. The outputs of evaluating the activation functions of each neuron with provided inputs are referred to herein as activations. Complex neural networks are designed to emulate how the human brain works, so computers can be trained to support poorly defined abstractions and problems where training data is available. ANNs are often used in image recognition, speech, and computer vision applications.

Natural Language Processing (NLP) is a field of AI and linguistics that studies problems inherent in process and manipulation of natural language, with an aim to increase the ability of computers to understand human languages. NLP focuses on extracting meaning from unstructured data.

Entity linking (EL) is referred to herein as a task of disambiguating, e.g. removing uncertainty, textual mentions by linking such mentions to canonical entities provided by a knowledge graph (KG). Text or textual data, T, is comprised of a set of mentions, M={m₁, m₂, . . . }, wherein each mention, mᵢ, is contained in the textual data, T. A knowledge graph (KG) is comprised of a set of entities, ε, with individual entities therein referred to herein as eᵢⱼ. Entity linking is a many-to-one function that links each mention, mᵢ ∈ M, to an entity in the KG. More specifically, the linking is directed to eᵢⱼ ∈ Cᵢ, where Cᵢ is a subset of relevant candidates, ε, for mention mᵢ.

A logical neural network (LNN) is neuro-symbolic framework designed to simultaneously provide key properties of both neural networks (NNs) and symbolic logic (knowledge and reasoning). More specifically, the LNN functions to simultaneously provide properties of learning and symbolic logic of knowledge and reasoning. The LNN creates a direct correspondence between artificial neurons and logical elements using an observation that the weights of the logical neurons are constrained to act a logical AND or logical OR gates. The LNNs shown and described employ rules expressed in first order logic (FOL), which is a symbolized reasoning in which each sentence or statement is broken down into a subject and a predicate. Each rule is a disambiguation model that captures specific characteristics of the linking. Given a rule template, the parameters of the rules in the form of the thresholding operations of predicates and the weights of the predicates that appear in the rules are subject to learning based on a labeled dataset. Accordingly, the LNN learns the parameters of the rules to enable and implement adjustment of the parameters.

Structurally, the LNN is a graph made up of syntax trees of all represented formulae connected to each other via neurons added for each proposition. Specifically, there exists one neuron for each logical operation occurring in each formula and, in addition, one neuron for each unique proposition occurring in any formula. All neurons return pairs of values in the range [0, 1] representing lower and upper bounds on the truth values of their corresponding sub-formulae and propositions.

Using the semantics of FOL, the LNN enforces constraints when learning operators. Examples of such operators include, but are not limited to, logical AND, shown herein as LNN-∧, and logical OR, shown herein as LNN-∨. Logical AND, LNN-∧, is expressed as:

max (0,min (1,β−w₁(1−x)−w₂(1−y)))

with the following constraints:

β−1(1−α)(w₁+w₂)≥α constraint 1

β−αw₁≤1−α constraint 2

β−αw₂≤1−α constraint 3

w₁, w₂≥0

where β, w₁, w₂ are learnable parameters, x,y ∈ [0,1] are inputs, and α∈ [½,1] is a hyperparameter. Similar to the logical AND, the logical OR is defined in terms of the logical AND as follows:

LNN-∨ (x,y)=1−LNN-∧ (1−x,1−y)

Conventionally, Boolean logic returns only 1 or True when both inputs are 1. The LNN relaxes the Boolean conjunction, e.g. logical AND, by using α as a proxy for 1 and 1−α as a proxy for 0.

Constraint 1 forces the output of the logical AND to be greater than α when both inputs are greater than α. Similarly, constraint 2 and constraint 3 constrain the behavior of the logical AND when one input is low and the other is high. More specifically, constraint 2 forces the output of the logical AND to be less than 1−α for y=1 and x≤1−α. This formulation allows for unconstrained learning when x,y ∈ [1−α, α]. Control of the extent of the learning may be obtained by changing α. In an exemplary embodiment, the constraints, e.g. constraint 1, constraint 2, and constraint 3, can be relaxed.

A feature is referred to herein as an attribute that measures a degree of similarity between a textual mention and a candidate entry. In an exemplary embodiment, features are generated using a catalogue of feature functions, including non-embedding and embedding based function. As shown and described herein, an exemplary set of non-embedding based feature functions are provided to measure similarity between a mention, mᵢ, and a candidate entity, eᵢⱼ. The name feature is a set of general purpose similarity functions, such as but not limited to Jaccard, Jaro Winkler, Levenshtein, and Partial Ratio, to compute the similarity between the name of the mention, mᵢ, and the name of the candidate entity, eᵢⱼ. The context feature is an aggregated similarity of context of the mention, mᵢ, to the description of the candidate entity, eᵢⱼ. In an exemplary embodiment, the context feature, Ctx, is assessed as follows:

Ctx (mᵢ, eᵢⱼ)=Σₘ_{ₖ}_{∈M\{m}_{ᵢ}_{}}pr(mₖ, eᵢⱼ▪desc)

where pr is a partial ratio measuring a similarity between each context mention and the description. In an exemplary embodiment, the partial ratio computes a maximum similarity between a short input string and substrings of a second, longer string. The type feature is an overlap similarity of mention mᵢ's type to a domain set of eᵢⱼ. In an exemplary embodiment, type information for each mention, mᵢ, is obtained using a trained Bi-directional Encoder Representations from Transformers (BERT) based entity type detection model. The entity prominence feature is a measure of prominence of candidate entity, eᵢⱼ, as the number of entities that link to candidate entity, eᵢⱼ, in a target knowledge graph, i.e. indegree (eᵢⱼ).

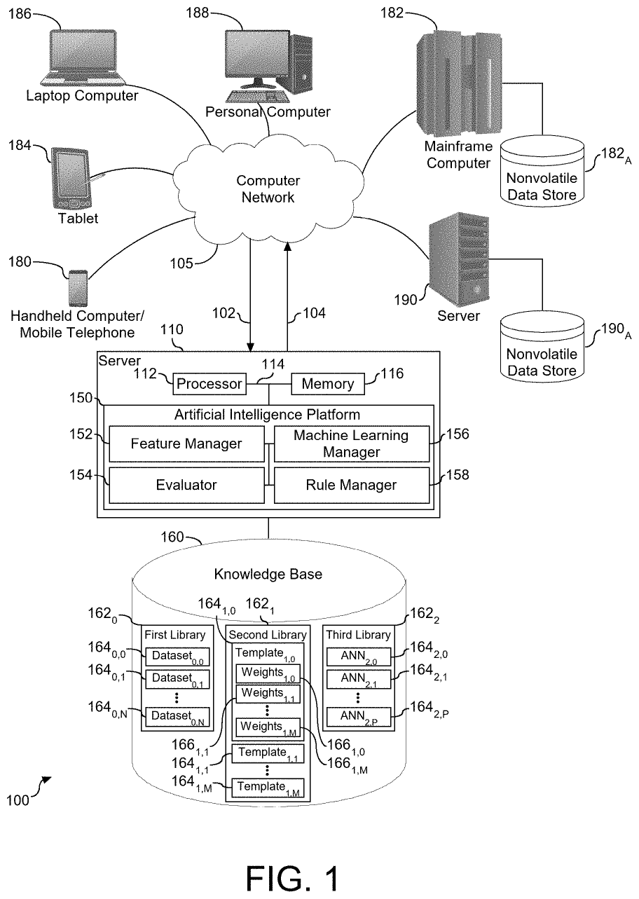

As shown and described in FIGS. 1-5, an entity linking (EL) algorithm composed of a disjunctive set of rules is reformulated into an LNN representation for learning. Entity linking is a restricted form of first order logic (FOL) rules comprising a set of Boolean predicates connected by logical operators in the form of logical AND (∧) and logical OR (∨). A Boolean predicate has the form fₖ>θ, wherein fₖ ∈ F is one of the feature functions, and θ is a learned thresholding operation. The following are examples of two entity linking rules:

R₁(mᵢ,eᵢⱼ)←jacc(mᵢ,eᵢⱼ)>θ₁∧ Ctx(mᵢ,eᵢⱼ)>θ₂

R₂(mᵢ,eᵢⱼ)←lev(mᵢ,eᵢⱼ)>θ₃∧ Prom(mᵢ,eᵢⱼ)>θ₄

Based on these examples, the first example rule, R₁(mᵢ,eᵢⱼ) evaluates to True if both the predicate jacc(mᵢ,eᵢⱼ)>θ₁ and the predicate Ctx(mᵢ,eᵢⱼ)>θ₂ are true, and the second example rule, R₂(mᵢ,eᵢⱼ), evaluates to True if both the predicate lev(mᵢ,eᵢⱼ)>θ₃ and the predicate Prom(mᵢ,eᵢⱼ)>θ₄ are true. In an exemplary embodiment, the rules, such as the example first and second rules, can be disjuncted together to form a larger EL algorithm. The following is an example of such an extension:

Links(mᵢ,eᵢⱼ)←R₁(mᵢ,eᵢⱼ)∨R₂(mᵢ,eᵢⱼ)

where Links(mᵢ,eᵢⱼ) evaluates to True if either one of the first or second rules evaluates to True. In an exemplary embodiment, the Links predicate represents the disjunction between at least two rules, and functions to store high quality links between mention and candidate entities that pass the conditions of at least one rule.

The EL algorithm also functions as a scoring mechanism. The following is an example of a scoring function based on the example first and second rules:

$$s ( {m}_{i} , {e}_{ij} ) = + ( \begin{matrix}{rw}_{1} \times ( {fw}_{1} \times jacc ( {m}_{i} , {e}_{ij} ) ) \times ( {fw}_{2} \times Ctx ( {m}_{i} , {e}_{ij} ) ) \\ {rw}_{2} \times ( {fw}_{3} \times jacc ( {m}_{i} , {e}_{ij} ) ) \times ( {fw}_{4} \times Ctx ( {m}_{i} , {e}_{ij} ) )\end{matrix} )$$

where rwᵢ is a manually assignable rule weight, and fwᵢ is a manually assignable feature weight. As shown and described herein, the learning is directed at the thresholding operations, θᵢ, the feature weights, fwᵢ, and the rule weights, rwᵢ.

Referring to FIG. 1, a block diagram (100) is provided to illustrate a computer system with tools to support a neuro-symbolic solution to entity linking, which in exemplary embodiment is applied to short-text scenarios. In general, entity linking extracts features measuring some degree of similarity between a textual mention and any one of several candidate entities. In an exemplary embodiment, short-text is directed to a single sentence or question. Challenges associated with the effective techniques in the short-text environment are limited context surrounding mentions. The system and associated tools, as described herein, combine logic rules and learning to facilitate combining multiple types of EL features with interpretability and learning using gradient based techniques. As shown, a server (110) is provided in communication with a plurality of computing devices (180), (182), (184), (186), (188), and (190) across a network connection (105). The server (110) is configured with a processing unit (112) operatively coupled to memory (114) across a bus (116). A tool in the form of an artificial intelligence (AI) platform (150) is shown local to the server (110), and operatively coupled to the processing unit (112) and memory (114). As shown, the AI platform (150) contains tools in the form of a feature manager (152), an evaluator (154), a machine learning (ML) manager (156), and a rule manager (158). Together, the tools provide functional support for entity linking, over the network (105) from one or more computing devices (180), (182), (184), (186), (188), and (190). The computing devices (180), (182), (184), (186), (188), and (190) communicate with each other and with other devices or components via one or more wires and/or wireless data communication links, where each communication link may comprise one or more of wires, routers, switches, transmitters, receivers, or the like. In this networked arrangement, the server (110) and the network connection (105) enables feature generation and application of the generated features to an EL algorithm composed of a disjunctive set of rules reformulated into an LNN representation for learning. Other embodiments of the server (110) may be used with components, systems, sub-systems, and/or devices other than those that are depicted herein.

The tools, including the AI platform (150), or in one embodiment, the tools embedded therein including the feature manager (152), the evaluator (154), the ML manager (156), and the rule manager (158), may be configured to receive input from various sources, including but not limited to input from the network (105), and an operatively coupled knowledge base (160). As shown herein, the knowledge base (160) includes a first library (162₀) of annotated datasets, shown herein as dataset_{0,0} (164_{0,0}), dataset_{0,1} (164_{0,1}), . . . , dataset_{0,N} (164_{0,N}). The quantity of datasets in the first library (162₀) is for illustrative purposes and should not be considered limiting. Similarly, in an exemplary embodiment, the knowledge base (160) may include one or more additional libraries each having one more datasets therein. As such, the quantity of libraries shown and described herein should not be considered limiting.

The various computing devices (180), (182), (184), (186), (188), and (190) in communication with the network (105) demonstrate access points for the AI platform (150) and the corresponding tools, e.g. managers and evaluator, including the feature manager (152), the evaluator (154), the ML manager (156), and the rule manager (158). Some of the computing devices may include devices for use by the AI platform (150), and in one embodiment the tools (152), (154), (156), and (158) to support generating a learned model with learned thresholding operations and weights for logical connectives, and dynamically generating a template for application of the learned model. The network (105) may include local network connections and remote connections in various embodiments, such that the AI platform (150) and the embedded tools (152), (154), (156), and (158) may operate in environments of any size, including local and global, e.g. the Internet. Accordingly, the server (110) and the AI platform (150) serve as a front-end system, with the knowledge base (160) and one or more of the libraries and datasets serving as the back-end system.

Data annotation is a process of adding metadata to a dataset, effectively labeling the associated dataset, and allowing ML algorithms to leverage corresponding pre-existing data classifications. As described in detail below, the server (110) and the AI platform (150) leverages input from the knowledge base (160) in the form of annotated data from one of the libraries, e.g. library (162₀) and a corresponding dataset, e.g. dataset_{0,1} (164_{0,1}). In an exemplary embodiment, the annotated data is in the form of entity-mention pairs, (mᵢ, eᵢⱼ), with each of these pairs having a corresponding label. Similarly, in an embodiment, the annotated dataset may be transmitted across the network (105) from one or more of the operatively coupled machines or systems. The AI platform (150) utilizes the feature manager (152) to generate a set of features for one or more of the entity-mention pairs in the annotated dataset. In an exemplary embodiment, the features are generated using a catalogue of feature functions, including non-embedding and embedding based functions to measure, e.g. compute, similarity between a mention, mᵢ, and a candidate entity, eᵢⱼ, for a subset of labeled entity mention pairs, with each of the features having a corresponding similarity predicate. Examples of such features include, but are not limited to, the name feature to compute the similarity between the name of the mention, mᵢ, and the name of the candidate entity, eᵢⱼ, the context feature to assess an aggregated similarity of context of the mention, mᵢ, to the description of the candidate entity, eᵢⱼ, the type feature as an overlap of similarity of mention mᵢ's type to a domain set of eᵢⱼ, and the entity prominence feature to measure prominence of a candidate entity, eᵢⱼ, as the number of entities that link to candidate entity, eᵢⱼ, in a target knowledge graph. Accordingly, the initial aspect is directed at a similarity assessment of the candidate entity-mention pairs, with the assessment generating a quantifying characteristic.

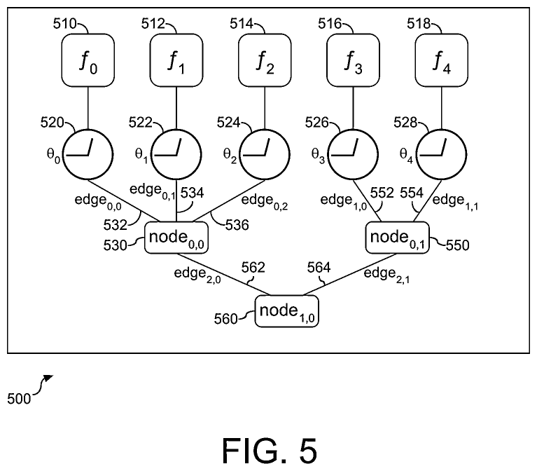

The evaluator (154), which is shown herein operatively coupled to the feature manager, subjects the generated features of the entity-mention pairs against an entity linking (EL) logical neural network (LNN) rule template. More specifically, the evaluator (154) re-formulates an entity linking algorithm composed of a disjunctive set of rules into an LNN representation. An example LNN rule template, e.g. LNN representation, is shown and described in FIG. 5. In an exemplary embodiment, one or more LNN rule templates are provided in the knowledge base, or otherwise communicated to the evaluator (154) across the network (105). By way of example, the knowledge base (160) is shown herein with a library, e.g. second library, (162₁) of LNN rule templates, shown herein as template_{1,0} (164_{1,0}), template_{1,1} (164_{1,1}), . . . , template_{1,M} (164_{1,M}). The quantity of rule templates in the second library (162₁) is for illustrative purposes and should not be considered limiting. Similarly, in an exemplary embodiment, the knowledge base (160) may include one or more additional libraries each having one more LNN rules templates therein. As shown by way of example in FIG. 5, the LNN rule template may be formulated as an inverted binary tree structure with one or more logically connected rules and corresponding connective weights. This example rule template is relatively rudimentary. In an exemplary embodiment, the LNN rule template may be expanded with additional layers in the binary tree and extended rules. Accordingly, as shown herein the generated features are subject to evaluation against a selected or identified LNN rule template.

The LNN rule template may be formulated as an inverted binary tree, with the features or a subset of feature functions represented in the leaf nodes of the binary tree. Each feature is associated with a corresponding threshold, θᵢ, also referred to herein as a thresholding operation. The internal nodes of the binary tree denote a logical AND or a logical OR operation. Edges are provided between each internal node and a thresholding operation, and between each internal node and a root node. In an exemplary embodiment, the binary tree may have multiple layers of internal nodes, with edges extended between adjacent layers of the nodes. Each edge has a corresponding weight, referred to herein as a rule weight. Each of the thresholding operations and the rule weights, collectively referred to herein as connective weights, are subject to learning. As shown herein, the ML manager (156), which is operatively coupled to the evaluator (154), is configured to leverage an ANN and a corresponding ML algorithm to learn the thresholding operations and connective weights. With respect to the thresholding operations, the ML manager (156) learns an appropriate threshold for each of the computed feature(s) as related to a corresponding similarity predicate. The evaluator (154) interfaces with the ML manager (156) to filter one or more of the features based on the learned thresholds(s). More specifically, the filtering enables the evaluator (154) to determine whether or not to incorporate the features into the LNN rule template, which takes place by removing a feature or assigning a non-zero score to the feature.

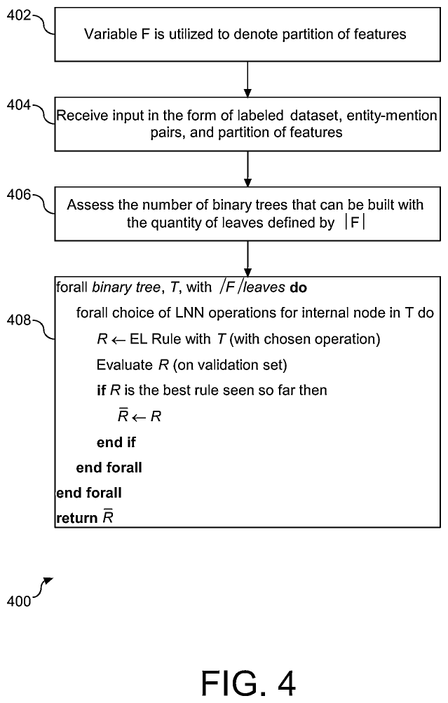

The connective weights are identified and associated with each rule template. As shown herein by way of example, template_{1,0} (164_{1,0}) has a set of connective weights, referred to herein as weights_{1,0} (166_{1,0}), weights_{1,1} (166_{1,1}), . . . , weights_{1,M} (166_{1,M}). Although not shown, each of the templates, e.g. Template_{1,1} (164_{1,1}) and Template_{1,M} (164_{1,M}), have corresponding connective weights. The quantity and characteristics of the weights is based on the corresponding template. Similarly, in an exemplary embodiment, the knowledge base (160) is provided with a third library (162₂) populated with ANNs, shown herein by way of example as ANN_{2,0} (164_{2,0}), ANN_{2,1} (164_{2,1}), . . . , ANN_{2,P} (164_{2,P}). The quantity of ANNs shown herein is for exemplary purposes and should not be considered limiting. In an embodiment, the ANNs may each have a corresponding or embedded ML algorithm. The thresholding operations and the connective weights are parameters that are individually or collectively subject to learning and selectively updating by the ML manager (156). Details of the learning are shown and described below in FIG. 4. Once the learning and updating is completed, a learned model with learned thresholding operations and weights for the logical connectives is generated.

As shown and described herein, rule templates with corresponding rules may be provided, with the thresholding operations and connective weights subject to learning to generate a learning model. In an exemplary embodiment, given a set of features and an EL annotated dataset, new rules with appropriate weights for the logical connective may be learned. The rule manager (158), shown herein operatively coupled to the evaluator (154), is provided to support such functionality. More specifically, the rule manager (158) learns one or more of the connected rules, dynamically generates a template for the binary tree, and learns logical rules associated with the template. Once learned, the rule manager (158) evaluates a selected rule on a labeled dataset, and selectively assigns the selected rule to a corresponding node in the binary tree. The rule manager (158) selectively assigns a conjunctive, e.g. logical AND, or a disjunctive, e.g. logical OR, operator to each internal node of the binary tree. Details of the functionality of the rule manager (158) with respect to rule learning and node operator assignments are shown and described in FIG. 4.

Although shown as being embodied in or integrated with the server (110), the AI platform (150) may be implemented in a separate computing system (e.g., 190) that is connected across the network (105) to the server (110). Similarly, although shown local to the server (110), the tools (152), (154), (156), and (158) may be collectively or individually distributed across the network (105). Wherever embodied, the feature manager (152), the evaluator (154), the ML manager (156), and the rule manager (158) are utilized to support and enable LNN EL.

Types of information handling systems that can utilize server (110) range from small handheld devices, such as a handheld computer/mobile telephone (180) to large mainframe systems, such as a mainframe computer (182). Examples of a handheld computer (180) include personal digital assistants (PDAs), personal entertainment devices, such as MP4 players, portable televisions, and compact disc players. Other examples of information handling systems include a pen or tablet computer (184), a laptop or notebook computer (186), a personal computer system (188) and a server (190). As shown, the various information handling systems can be networked together using computer network (105). Types of computer network (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes nonvolatile data store (190_{A}), and mainframe computer (182) utilizes nonvolatile data store (182_{A}). The nonvolatile data store (182_{A}) can be a component that is external to the various information handling systems or can be internal to one of the information handling systems.

Information handling systems may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

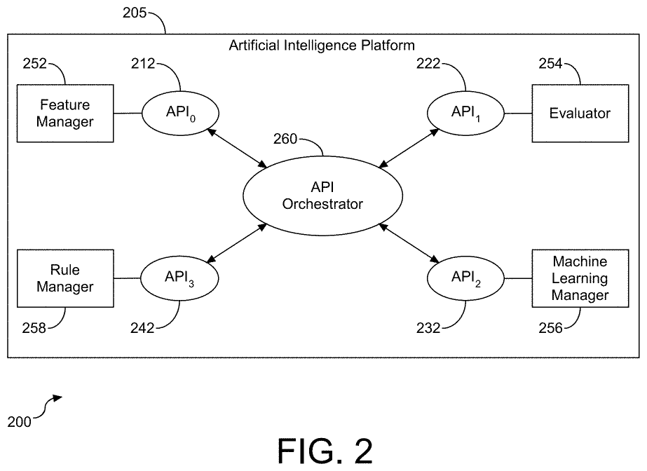

An Application Program Interface (API) is understood in the art as a software intermediary between two or more applications. With respect to the embodiments shown and described in FIG. 1, one or more APIs may be utilized to support one or more of the AI platform tools, including the feature manager (152), evaluator (154), ML manager (156), and the rule manager (158), and their associated functionality. Referring to FIG. 2, a block diagram (200) is provided illustrating the AI platform tools and their associated APIs. As shown, a plurality of tools are embedded within the AI platform (205), with the tools including the feature manager (252) associated with API₀ (212), the evaluator (254) associated with API₁ (222), the ML manager (256) associated with API₂ (232), and the rule manager (258) associated with API₃ (242). Each of the APIs may be implemented in one or more languages and interface specifications.

API₀ (212) provides support for generating a set of features for entity-mention pairs. API₁ (222) provides support for evaluating the generated features against an EL LNN rule template. API₂ (232) provides support for learned thresholding operations and connective weights in the rule template. API₃ (242) provides support for learning the EL rules and selectively assigning the learned rules to the template.

As shown, each of the APIs (212), (222), (232), and (242) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

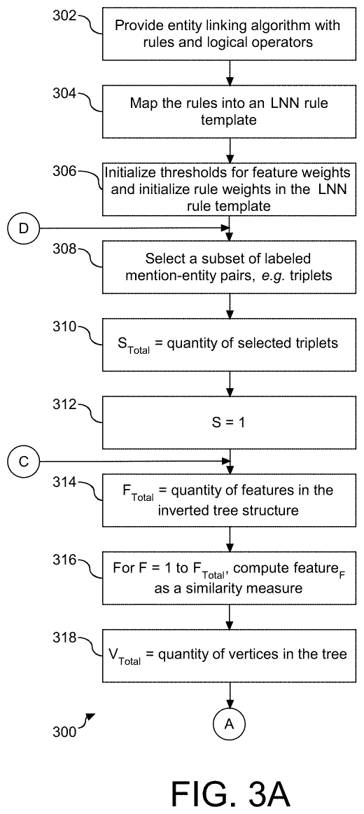

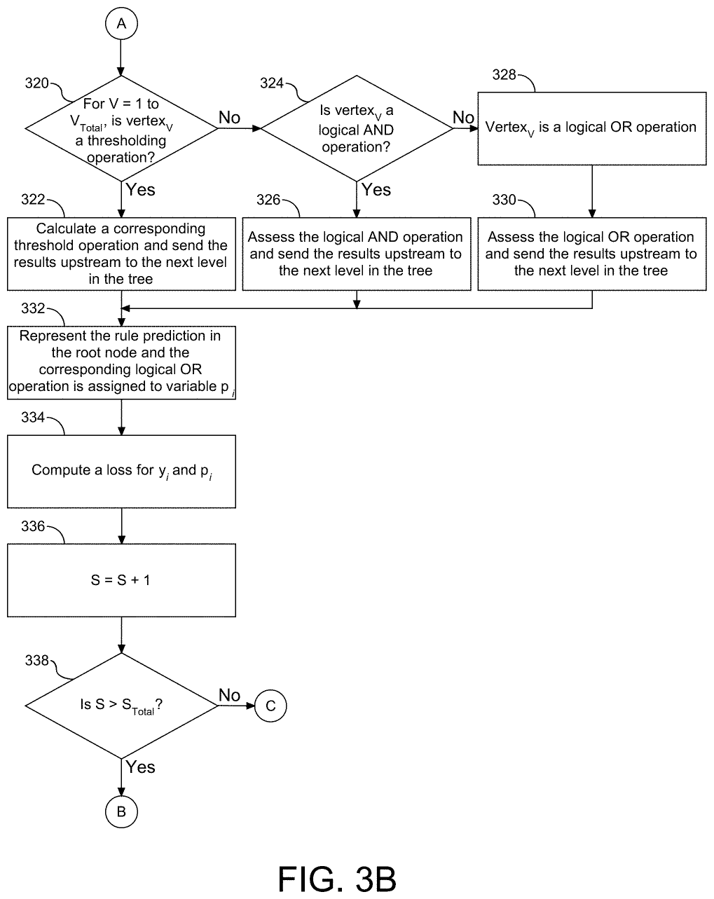

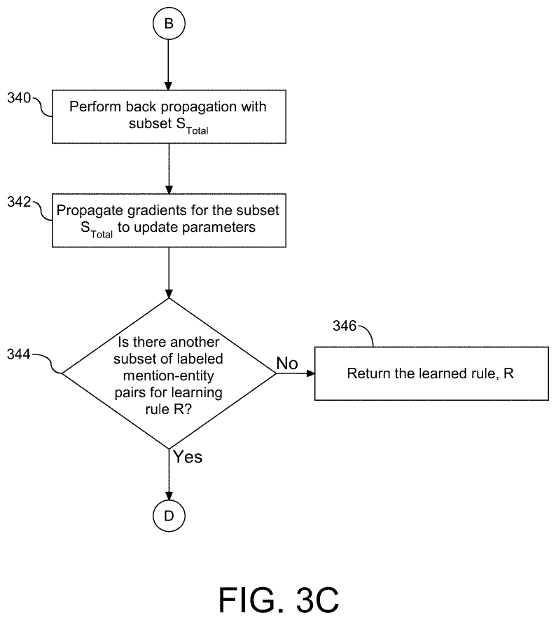

Referring to FIGS. 3A-3C, a flow chart (300) is provided to illustrate a process for learning thresholding operations and weights in an entity linking algorithm. As shown, an entity linking (EL) algorithm is provided with rules in the form of Boolean predicates connected by logical AND and logical OR operators (302). To facilitate and enable learning of the thresholding operations and weights in the EL algorithm, the Boolean valued logic rules are mapped into an LNN formalism (304), where the LNN constructs logical OR and logical AND in the LNN formalism allow for continuous real-value number in [0,1]. In an exemplary embodiment, the LNN formalism may be an inverted tree structure with features assigned to leaf nodes and entity linking rules are represented in the internal nodes and the root node. Each LNN operator produces a value in [0,1] based on the values of the inputs, their weights, and their bias, β, wherein both the weights and the bias are learnable parameters. Internal nodes of the LNN formalism, also referred to herein as an LNN rule template is comprised of external nodes operatively connected to internal nodes via corresponding links. The external nodes represent features or feature nodes and the internal nodes denote one of a logical AND, logical OR, or a thresholding operation.

The thresholds for feature weights and rules weights in the LNN formalism, e.g. LNN rule template, are initialized (306). In an exemplary embodiment, the feature weights and the rule weights are collectively referred to herein as weights. Following the initialization at step (306), a subset of labeled mention-entity pairs, S, e.g. triplets, in a labeled dataset, L, is selected or received (308). In an exemplary embodiment, the selection at step (308) is a random selection of mention-entity pairs. Each triplet is represented as (mᵢ, eᵢ, yᵢ), where mᵢ denotes a mention, eᵢ denotes an entity, and yᵢ denotes a match or a non-match, where in a non-limiting exemplary embodiment 1 is a match and 0 is a non-match. The variable S_{Total} is assigned to the quantity of selected triplets in the subset (310), and a corresponding triplet counting variable, S, is initialized (312). The quantity of features in the inverted tree structure are known or determined, and the feature quantity is assigned to the variable F_{Total} (314). For each feature, from F=1 to F_{Total}, a similarity measure, also referred to herein as a feature function, feature_{F}, between a mention, mᵢ, and a candidate entity, eᵢ, is computed (316). Examples of the feature measurement include, but are not limited to the name, context, type, and entity prominence, as described above. As shown, a set of features, which in an exemplary embodiment are similarity predicates, are computed for each entity mention pair, with the set of features leveraging one or more string similarity functions that compare the mention, mᵢ, with the candidate entity, eᵢ.

After the features are computed, each entity-mention pair is subject to evaluation against an EL logical neural network (LNN) rule template, with the template having one or more logically connected rules and corresponding connective weights, organized in a binary tree, also referred to herein as a hierarchical structure. The binary tree is organized with a root node operatively coupled to two or more internal nodes, with the internal nodes operatively coupled to leaf nodes that reside in the last level of the binary tree. As shown herein, the triplet is evaluated through a rule, R, that is the subject of the learning. The evaluation is directed at the triplet, triplet_{S}, and is processed through the tree structure in a bottom-up manner, e.g. starting with the leaf nodes that represent the features. Each node in the tree is referred to herein as a vertex, v, and each vertex may be the root node, an internal node, or a leaf node. The quantity of vertices in the tree is assigned to the variable v_{Total} (318). For each vertex, from v=1 to v_{Total}, it is determined if vertexᵥ is a thresholding operation (320). Each feature is represented in a leaf node, and each feature has a corresponding or associated thresholding operation. A positive response to the determination at step (320) is followed by calculating a corresponding threshold operation, as follows:

fᵢ[1+exp(θ^{v}−fᵢ)]⁻¹

and sending the calculation results upstream to the next level in the inverted tree structure (322). In an exemplary embodiment, the assessment at step (322) is directed at filtering of features based on their corresponding learned threshold, θ. As an example, if the feature value, fᵢ, is 0.1, depending on the value of [1+exp(θ^{v}−fᵢ)]⁻¹, could result in a number between 1 and 0.29. For example, if θ^{v} is 0.9, then the result of the assessment of the thresholding operation would be 0.3. Based on this value, when multiplied with fᵢ, this would downscale the output to a value close to 0, effectively removing the feature from consideration. Accordingly, the feature filtering at step (322) selectively incorporates the feature into the LNN rules template by effectively removing a feature or assigning a non-zero score to the feature.

If the response at step (320) is negative, it is then determined if vertexᵥ is a logical AND operation (324). A positive response to the determination at step (324) is followed by assessing the logical AND operation as follows:

$$max ( 0 , min ( 1 , {β}^{v} - {\sum }_{i} {w}_{i}^{v} ( 1 - {f}_{i} ) ) )$$

and sending the calculation results upstream to the next level in the inverted tree structure (326). A negative response to the determination at step (324) is an indication that vertexᵥ is a logical OR operation (328). An assessment of the logical OR operation is conducted as follows:

$$1 - max ( 0 , min ( 1 , {β}^{v} - {\sum }_{i} {w}_{i}^{v} {f}_{i} ) )$$

and the calculation results are sent upstream to the next level in the inverted tree structure (330). Following the assessment of each of the vertices as shown at step (322), (326) and (330), the rule prediction as represented in the root node and the corresponding logical OR operation, is assigned to the variable pᵢ (332). The triplet, triplet_{S}, has an entity, yᵢ, and a loss is computed for yᵢ and pᵢ (334). Details of the loss computation are shown and described below. As shown at step (320)-(332), the thresholds and weights, collectively referred to herein as connective weights, are subject to learning. More specifically, an artificial neural network (ANN) and a corresponding machine learning (ML) algorithm are utilized to compute the loss(es) corresponding to a feature prediction.

Following step (334), the triplet counting variable, S, is incremented (336), and it is determined if each of the triplets in the subset have been evaluated (338). A negative response to the determination is followed by a return to step (314) to evaluate the next triplet in the subset, and a positive response concludes the initial aspect of the rule evaluation. More specifically, the positive response to the determination at step (338) is followed by performing back propagation, including computing gradients from all losses within the subset, S_{Total} (340), and propagating gradients for the subset S_{Total} to update the following parameters: θ^{v}, β^{v}, and wᵢ^{v} in rule R (342). Accordingly, an appropriate threshold is learned for each of the computed features. In an exemplary embodiment, the ANN and corresponding ML algorithm train the LNN formulated EL rules over the labeled dataset and use a margin-ranking loss over all the candidates in Cᵢ to perform gradient descent. The loss function L (mᵢ, Cᵢ) for mention mᵢ and candidates set Cᵢ is defined as:

$${\sum }_{{e}_{i n} ∈ {C}_{i} \backslash \{ {e}_{ip} \}} max ( 0 , - ( s ( {m}_{i} , {e}_{ip} ) - s ( {m}_{i} , {e}_{i n} ) ) + μ )$$

where, eᵢₚ ∈ Cᵢ is a positive candidate, Cᵢ\{eᵢₚ} is a negative set of candidates, and μ is a margin hyper parameter. The positive and negative labels are obtained from the labels Lᵢ. Thereafter, it is determined if there is another subset of labeled mention-entity pairs in the labeled data set for learning rule R (344). A negative response is followed by returning the learned rule, R, (346) and a positive response is followed by a return to step (308). Accordingly, a labeled dataset and corresponding entity-mention pairs therein are processed through the LNN formalism to learn a corresponding rule, R, including the connective weights in the links connecting the nodes of the tree structure.

As shown in FIGS. 3A-3C, given a set of rule templates, a set of features, and an EL dataset with labels, a LNN is used to learning appropriate weights for the logical connectives. Referring to FIG. 4 a flow chart (400) is provided to illustrate a process for using a LNN to learn new rules with appropriate weights for logical connectives. As described above, an exemplary set of non-embedding based feature functions are provided to measure similarity between a mention, mᵢ, and a candidate entity, eᵢⱼ. The exemplary set includes the name feature, the context feature, the type feature, and the entity prominence feature. The variable F is utilized herein to denote a partition of such features (402). Input is in the form of the labeled dataset, L, e.g. entity-mention pairs, and the partition of features, F, (404). The number of binary trees that can be built with the quantity of leaves defined by |F| is assessed by: C(|F|−1), where C denotes a Catalan number, (406). In the steps described below, it is assumed that a node will have one operation with the optional assignment of a logical AND or logical OR operator to the node. The following pseudo code demonstrates the process of choosing and assigning a logical operator to the internal nodes of the binary tree:

```
    forall binary tree T with | F | leaves do
      forall choice of LNN operations for internal nodes in T do
        R ← EL Rule with T (with chosen operators)
        Evaluate R (on validation set, e.g. labeled dataset)
        if R is the best rule seen so far then
          R̅ ← R
        end if
      end forall
    end forall
return R̅
```

The pseudo code demonstrates the process of learning one or more logically connected rules, and more specifically, the aspect of dynamically generating a template. In an exemplary embodiment, the template is a hierarchical structure in the form of a binary tree, and the nodes that are processed for the rule assignment is an internal node. More specifically, as shown, a logical rule, R, is learned based on the generated template, and a selected rule is evaluated on the validation set, e.g. labeled dataset. Based on this evaluation, the selected rule is selectively assigned to a corresponding internal node in the hierarchical structure. In an exemplary embodiment, the assigned rule is a conjunctive or disjunctive LNN operator. Accordingly, as shown herein, given a set of features and an EL labeled data set, new rules with corresponding weights are learned for logical connectives.

Referring to FIG. 5, a block diagram (500) is provided to illustrate an example LNN reformulation of an EL algorithm. As shown in this example, the reformulation is an inverted tree structure with features and corresponding thresholds, logical operators, and associated weights. In this example, five features are shown. In an exemplary embodiment, there may be a different quantity of features in the reformulation, and as such the quantity shown and described herein should not be considered limiting. The five features, referred to herein as f₀ (510), f₁ (512), f₂ (514), f₃ (516), and f₄ (518), are represented as individual leaf nodes of an inverted tree structure. Each of the features is shown with a corresponding threshold. More specifically, feature f₀ (510) is shown operatively connected with corresponding threshold operation, θ₀ (520), f₁ (512) is shown operatively connected with corresponding threshold operation, θ₁ (522), feature f₂ (514) is shown operatively connected with corresponding threshold operation, θ₂ (524), feature f₃ (516) is shown operatively connected with corresponding threshold operation, θ₃ (526), and feature f₄ (518) is shown operatively connected with corresponding threshold operation, θ₄ (528). Each of the threshold operations is subject to learning and is directly related to one or more feature functions.

As further shown, a first set of internal nodes, shown herein as internal node_{0,0} (530) and internal node_{0,1} (550) of the inverted tree are operatively connected to a selection of the features and their corresponding thresholds. Internal node_{0,0} (530) is operatively connected to features f₀ (510), f₁ (512), and f₂ (514), and internal node_{0,1} (550) is operatively connected to features f₃ (516) and f₄ (518). An edge is shown operatively connecting the leaf nodes and their corresponding threshold to the first set of internal nodes (530) and (550). Specifically, edge_{0,0} (532) operatively connects feature f₀ (510) and corresponding threshold θ₀ (520) to node_{0,0} (530), edge_{0,1} (534) operatively connects feature f₁ (512) and corresponding threshold θ₁ (522) to node_{0,0} (530), and edge_{0,2} (536) operatively connect features f₂ (514) and corresponding threshold θ₂ (524) to node_{0,0} (530). Similarly, edge_{1,0} (552) connects feature f₃ (516) and corresponding threshold θ₄ (526) to node_{0,1} (550), and edge_{1,1} (554) connects feature f₅ (518) and corresponding threshold θ₅ (528) to node_{0,1} (550). Each of the edges, including edge_{0,0} (532), edge_{0,1} (534), edge_{0,2} (536), edge_{1,0} (552), and edge_{1,1} (554), has a separate corresponding weights, and similar to the thresholds, is subject to learning. In an exemplary embodiment, these weights are referred to as the feature weights, f_{w}, with edge_{0,0} (532) having feature weight fw₀, edge_{0,1} (534) having feature weight fw₁, edge_{0,2} (536) having feature weight fw₂, edge_{1,0} (552) having feature weight fw₃, and edge_{1,1} (554) having feature weight fw₄. A second internal node, node_{1,0} (560) is shown operatively coupled to internal node_{0,0} (530) and internal node_{0,1} (550). Two edges are shown operatively coupled to the second internal node node_{1,0} (560), including edge_{2,0} (562) and edge_{2,1} (564). Each of these edges, namely edge_{2,0} (562) and edge_{2,1} (564), has a corresponding weight, referred to herein as a rule weight, rw. Namely, edge_{2,0} (562) has rule weight rw₀ and edge_{2,1} (564) has rule weight rw₁. Similar to the feature weight(s) and thresholds, the rule weights are subject to learning.

In this example, each internal node_{0,0} (530) and internal node_{0,1} (550), represent LNN logical AND (∧) operations, and the second internal node, also referred to in this example as the root node, node_{1,0} (560) represents a logical OR (∨). By way of example, the Rule, R₁, associated with internal node_{0,0} (530) is as follows:

R₁: (f₀>θ₀)∧(f₁>θ₁)∧(f₂>θ₂)

where R₁ evaluates to True if f₀>θ₀ is true, f₁>θ₁ is true, and f₂>θ₂ is true. Similarly, by way of example, the second rule, Rule, R₂, associated with internal node_{0,1} (550) is as follows:

R₂: (f₃>θ₃)∧(f₄>θ₄)

where R₂ evaluates to True if f₃>θ₃ is true and f₄>θ₄ is true. The second internal node, node_{1,0} (560) is a root node of the inverted tree structure, and as shown herein it combines the Boolean logic of internal node_{0,0} (530) and internal node_{0,1} (550). By way of example, the rule, R₃, of the root node, node_{1,0} (160), is as follows:

R₁∨R₂

where R₃ evaluates to True if either one of the first or second rules, R₁ and R₂, respectively, evaluates to True.

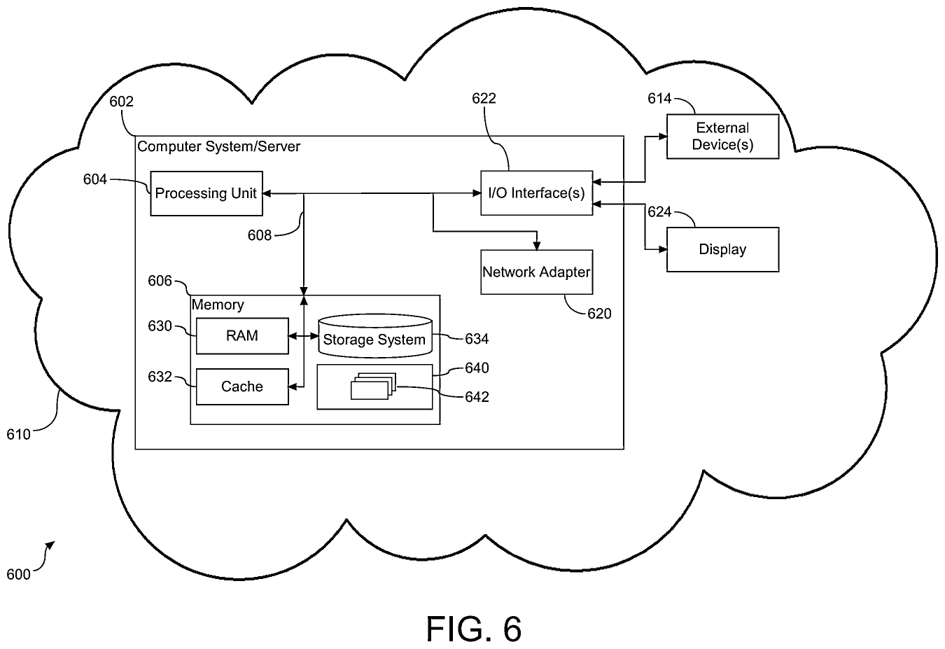

Aspects of the tools (152), (154), (156), and (158) and their associated functionality may be embodied in a computer system/server in a single location, or in an embodiment, may be configured in a cloud based system sharing computing resources. With references to FIG. 6, a block diagram (600) is provided illustrating an example of a computer system/server (602), hereinafter referred to as a host (602) in communication with a cloud based support system, to implement the system and processes described above with respect to FIGS. 1-5. Host (602) is operational with numerous other general purpose or special purpose computing system environments or configurations. Examples of well-known computing systems, environments, and/or configurations that may be suitable for use with host (602) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (602) may be described in the general context of computer system-executable instructions, such as program modules, being executed by a computer system. Generally, program modules may include routines, programs, objects, components, logic, data structures, and so on that perform particular tasks or implement particular abstract data types. Host (602) may be practiced in distributed cloud computing environments (610) where tasks are performed by remote processing devices that are linked through a communications network. In a distributed cloud computing environment, program modules may be located in both local and remote computer system storage media including memory storage devices.

As shown in FIG. 6, host (602) is shown in the form of a general-purpose computing device. The components of host (602) may include, but are not limited to, one or more processors or processing units (604), a system memory (606), and a bus (608) that couples various system components including system memory (606) to processor (604). Bus (608) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (602) typically includes a variety of computer system readable media. Such media may be any available media that is accessible by host (602) and it includes both volatile and non-volatile media, removable and non-removable media.

Memory (606) can include computer system readable media in the form of volatile memory, such as random access memory (RAM) (630) and/or cache memory (632). By way of example only, storage system (634) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (608) by one or more data media interfaces.

Program/utility (640), having a set (at least one) of program modules (642), may be stored in memory (606) by way of example, and not limitation, as well as an operating system, one or more application programs, other program modules, and program data. Each of the operating systems, one or more application programs, other program modules, and program data or some combination thereof, may include an implementation of a networking environment. Program modules (642) generally carry out the functions and/or methodologies of embodiments of the entity linking in a logical neural network. For example, the set of program modules (642) may include the modules configured as the tools (152), (154), (156), and (158) described in FIG. 1.

Host (602) may also communicate with one or more external devices (614), such as a keyboard, a pointing device, a sensory input device, a sensory output device, etc.; a display (624); one or more devices that enable a user to interact with host (602); and/or any devices (e.g., network card, modem, etc.) that enable host (602) to communicate with one or more other computing devices. Such communication can occur via Input/Output (I/O) interface(s) (622). Still yet, host (602) can communicate with one or more networks such as a local area network (LAN), a general wide area network (WAN), and/or a public network (e.g., the Internet) via network adapter (620). As depicted, network adapter (620) communicates with the other components of host (602) via bus (608). In one embodiment, a plurality of nodes of a distributed file system (not shown) is in communication with the host (602) via the I/O interface (622) or via the network adapter (620). It should be understood that although not shown, other hardware and/or software components could be used in conjunction with host (602). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (606), including RAM (630), cache (632), and storage system (634), such as a removable storage drive and a hard disk installed in a hard disk drive.

Computer programs (also called computer control logic) are stored in memory (606). Computer programs may also be received via a communication interface, such as network adapter (620). Such computer programs, when run, enable the computer system to perform the features of the present embodiments as discussed herein. In particular, the computer programs, when run, enable the processing unit (604) to perform the features of the computer system. Accordingly, such computer programs represent controllers of the computer system.

In one embodiment, host (602) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

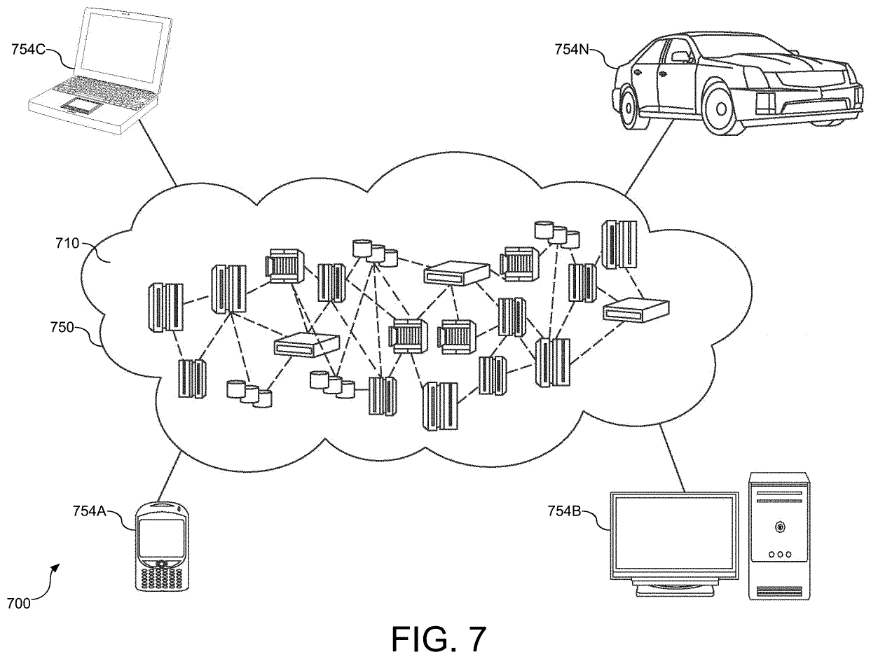

Referring now to FIG. 7, an illustrative cloud computing network (700). As shown, cloud computing network (700) includes a cloud computing environment (750) having one or more cloud computing nodes (710) with which local computing devices used by cloud consumers may communicate. Examples of these local computing devices include, but are not limited to, personal digital assistant (PDA) or cellular telephone (754A), desktop computer (754B), laptop computer (754C), and/or automobile computer system (754N). Individual nodes within nodes (710) may further communicate with one another. They may be grouped (not shown) physically or virtually, in one or more networks, such as Private, Community, Public, or Hybrid clouds as described hereinabove, or a combination thereof. This allows cloud computing environment (700) to offer infrastructure, platforms and/or software as services for which a cloud consumer does not need to maintain resources on a local computing device. It is understood that the types of computing devices (754A-N) shown in FIG. 7 are intended to be illustrative only and that the cloud computing environment (750) can communicate with any type of computerized device over any type of network and/or network addressable connection (e.g., using a web browser).

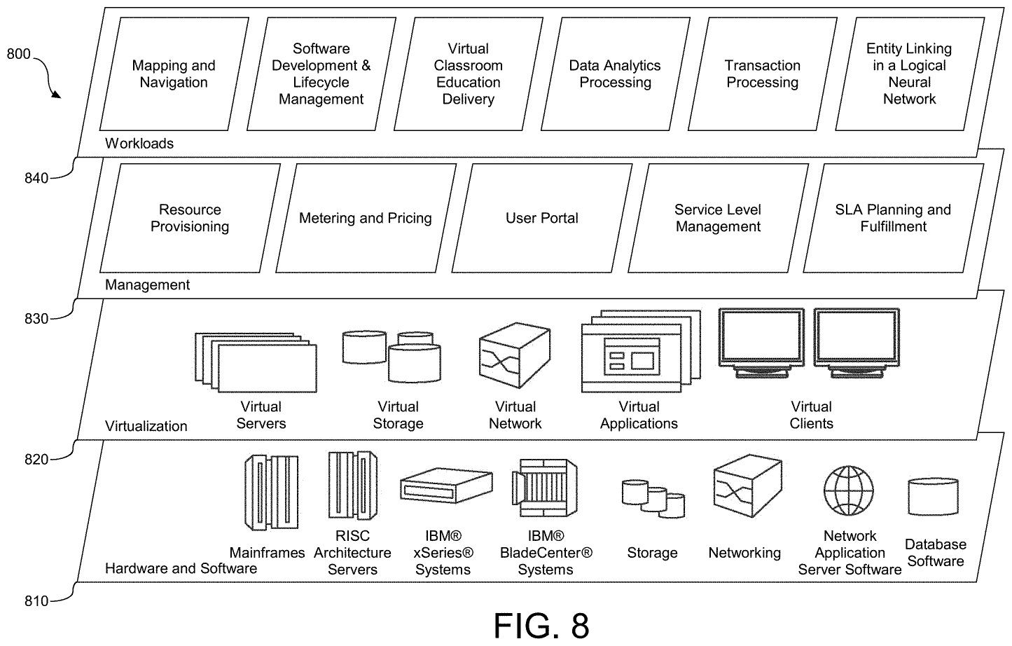

Referring now to FIG. 8, a set of functional abstraction layers (800) provided by the cloud computing network of FIG. 7 is shown. It should be understood in advance that the components, layers, and functions shown in FIG. 8 are intended to be illustrative only, and the embodiments are not limited thereto. As depicted, the following layers and corresponding functions are provided: hardware and software layer (810), virtualization layer (820), management layer (830), and workload layer (840). The hardware and software layer (810) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (820) provides an abstraction layer from which the following examples of virtual entities may be provided: virtual servers; virtual storage; virtual networks, including virtual private networks; virtual applications and operating systems; and virtual clients.

In one example, management layer (830) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (840) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and entity linking in a logical neural network.

The system and flow charts shown herein may also be in the form of a computer program device for entity linking in a logical neural network. The device has program code embodied therewith. The program code is executable by a processing unit to support the described functionality.

While particular embodiments have been shown and described, it will be obvious to those skilled in the art that, based upon the teachings herein, changes and modifications may be made without departing from its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles.

The present embodiment(s) may be a system, a method, and/or a computer program product. In addition, selected aspects of the present embodiment(s) may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiment(s) may take the form of computer program product embodied in a computer readable storage medium (or media) having computer readable program instructions thereon for causing a processor to carry out aspects of the present embodiment(s). Thus embodied, the disclosed system, a method, and/or a computer program product are operative to improve the functionality and operation of dynamical orchestration of a pre-requisite driven codified infrastructure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiment(s).

Aspects of the present embodiment(s) are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiment(s). In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiment(s). In particular, the annotation of unstructured NL data and extraction of facts into a structured format may be carried out by different computing platforms or across multiple devices. Furthermore, the libraries may be localized, remote, or spread across multiple systems. Accordingly, the scope of protection of the embodiment(s) is limited only by the following claims and their equivalents.

What is claimed is:

1. A computer system comprising:
a processor operatively coupled to memory;
an artificial intelligence (AI) platform, operatively coupled to the processor, comprising:
a feature manager to generate a set of features for one or more entity-mention pairs in an annotated dataset;
an evaluator configured to evaluate the generated set of features of the one or more entity-mention pairs against an entity linking (EL) LNN rule template, the template having one or more logically connected rules and corresponding connective weights organized in a hierarchical structure;
a machine learning (ML) manager, operatively coupled to the evaluator, configured to leverage an artificial neural network (ANN) and a corresponding ML algorithm to learn the connective weights;
the ML manager configured to selectively update the connective weights associated with the logically connected rules; and
generate a learned model with learned thresholds and the learned connective weights for the logically connected rules.

2. The system of claim 1, wherein the evaluation further comprises the evaluator to re-formulate an entity linking algorithm composed of a disjunctive set of rules into an LNN representation.

3. The system of claim 2, wherein the entity-mention pair evaluation further comprises the evaluator to compute one or more features for a subset of labeled entity-mention pairs, wherein each of the features has a corresponding similarity predicate.

4. The system of claim 3, further comprising the ML manager to leverage the ANN and the ML algorithm to learn an appropriate threshold for each of the computed one or more features as related to the corresponding similarity predicate.

5. The system of claim 4, further comprising the evaluator to filter the computed one or more features based on their corresponding learned threshold, and selectively incorporate the computed one or more features into the LNN rule template responsive to the filtering, the selective incorporation including removal of a feature or assignment of a non-zero score to the feature.

6. The system of claim 2, further comprising a rule manager, operatively coupled to the evaluator, configured to:
learn one or more of the logically connected rules;
dynamically generate a template for the hierarchical structure;
learn a logical rule based on the dynamically generated template;
evaluate a selected rule on a labeled dataset; and
selectively assign the selected rule to a corresponding node in the hierarchical structure.

7. The system of claim 6, wherein the template is a binary tree and the corresponding node is an internal node, and further comprising the rule manager to selectively assign a conjunctive or disjunctive LNN operator to the internal node.

8. A computer program product configured to interface with a computer readable storage medium having program code embodied therewith, the program code executable by a processor to:
generate features for one or more entity-mention pairs in an annotated dataset;
evaluate the generated features of the one or more entity-mention pairs against a an entity linking (EL) LNN rule template, the template having one or more logically connected rules and corresponding connective weights organized in a hierarchical structure;
leverage an artificial neural network (ANN) and a corresponding ML algorithm to learn the connective weights;
selectively update the connective weights associated with the logically connected rules; and
generate a learned model with learned thresholds and the learned connective weights for the logically connected rules.

9. The computer program product of claim 8, wherein the evaluation of each entity-mention pair against an LNN rule template further comprises program code configured to re-formulate an entity linking algorithm composed of a disjunctive set of rules into an LNN representation.

10. The computer program product of claim 9, wherein the entity-mention pair evaluation further comprises program code configured to compute a set of features for each entity-mention pair, wherein each of the features has a corresponding similarity predicate.

11. The computer program product of claim 10, further comprising program code configured to:
leverage the ANN and the ML algorithm to learn an appropriate threshold for each of the computed one or more features as related to the corresponding similarity predicate;
filter the computed one or more features based on their corresponding learned threshold; and
selectively incorporate the computed one or more features into the LNN rule template, the selective incorporation including removal of a feature or assignment of a non-zero score to the feature.

12. The computer program product of claim 9, further comprising program code configured to:
learn one or more of the logically connected rules;
dynamically generate a template for the hierarchical structure;
learn a logical rule based on the dynamically generated template;
evaluate a selected rule on a labeled dataset; and
selectively assign the selected rule to a corresponding node in the hierarchical structure.

13. The computer program product of claim 12, wherein the template is a binary tree and the corresponding node is an internal node, and further comprising program code configured to selectively assign a conjunctive or disjunctive LNN operator to the internal node.

14. A method comprising:
generating features for one or more entity-mention pairs in an annotated dataset;
evaluating the generated features of the one or more entity-mention pairs against an entity linking (EL) logical neural network (LNN) rule template, the template having one or more logically connected rules and corresponding connective weights organized in a hierarchical structure;
leveraging an artificial neural network (ANN) and a corresponding machine learning (ML) algorithm to learn the connective weights;
selectively updating the connective weights associated with the logically connected rules; and
generating a learned model with learned thresholds and the learned connective weights for the logically connected rules.

15. The method of claim 14, wherein the entity-mention pair evaluation includes re-formulating an entity linking algorithm composed of a disjunctive set of rules into an LNN representation.

16. The method of claim 15, wherein the entity-mention pairs evaluation includes computing a set of features for each entity-mention pair, wherein each of the features has a corresponding similarity predicate.

17. The method of claim 16, further comprising leveraging the ANN and the ML algorithm to learn an appropriate threshold for each of the computed one or more features as related to the corresponding similarity predicate.

18. The method of claim 17, further comprising filtering the computed one or more features based on their corresponding learned threshold, and selectively incorporating the computed one or more features into the LNN rule template responsive to the filtering, the selective incorporation including removing a feature or assigning a non-zero score to the feature.

19. The method of claim 15, further comprising:
learning one or more of the logically connected rules, including dynamically generating a template for the hierarchical structure;
learning a logical rule based on the dynamically generated template;
evaluating a selected rule on a labeled dataset; and
selectively assigning the selected rule to a corresponding node in the hierarchical structure.

20. The method of claim 19, wherein the template is a binary tree and the corresponding node is an internal node, and further comprising selectively assigning a conjunctive or disjunctive LNN operator to the internal node.
